(19) United States
(12) Patent Application Publication
(10) Pub. No.: US 2013/0166436 A1
(43) Pub. Date: Jun. 27, 2013

(54) DERIVING BUYER PURCHASING POWER FROM BUYER PROFILE AND SOCIAL NETWORK DATA

(71) Applicant: Ike O. Eze, Oakland, CA (US)

(72) Inventor: Ike O. Eze, Oakland, CA (US)

(21) Appl. No.: 13/724,655

(22) Filed: Dec. 21, 2012

Related U.S. Application Data
(60) Provisional application No. 61/579,532, filed on Dec. 22, 2011.

(51) Int. Cl. G06Q 40/02; G06Q 50/00

(52) U.S. Cl. CPC G06Q 40/025; G06Q 50/01
USPC 705/38

(57) ABSTRACT

Embodiments of a purchase power determination process for use in electronic commerce systems are described. The process correlates a person's actual, estimated or modeled credit score information with certain user profile and social network information to compile an overall score that encapsulates the person's purchasing power. The user profile information can include subjective information, such as user preferences, background, affiliations, behavior patterns, and so on. The social network information includes information regarding social network sites used by the person and the actual or estimated credit scores or financial data of other individuals linked to the person through these social networks.

### CROSS-REFERENCE TO RELATED APPLICATIONS

The present application claims the benefit of the U.S. Provisional Application No. 61/579,532 filed on Dec. 22, 2011, and entitled “Deriving Buyer Purchasing Power from Buyer Profile and Social Network Data.”

### FIELD

Embodiments of the invention relate generally to electronic commerce systems, and more specifically to deriving buyer purchasing power in electronic commerce applications.

### BACKGROUND

Online commerce sites require accurate purchase power information about buyers to determine if buyers are qualified to purchase goods or services that are offered online, or to extend credit to potential purchasers. Purchase or purchasing power can be generally defined as the ability of person to purchase goods and services given their income, assets, creditworthiness, or other relevant factors. A major determinant of a person's purchase power in present e-commerce environments is a person's credit risk as provided by one of the major credit bureaus, e.g., Equifax, Transunion, or Experian. Credit risk, exhibited via a credit score provided by one of these bureaus generally reflects a person's creditworthiness and is expressed as a number that represents a risk level to a lender. The higher the credit score, the more creditworthy a person is, and a high credit score generally allows a person to borrow money at better rates and under better terms. Financial institutions typically offer many different loan or credit products to consumers depending upon the financial profile of the borrowers.

The credit score, however provides a relatively incomplete picture of a person's overall purchase power. Credit scores generally reflect the nature of historical transactions between a person and established retailers and credit card companies based on the repayment or payment history of the person. Certain people with strong purchase power may not necessarily have high credit scores because of certain financial practices, such as not using credit cards, or negative items in their credit history. Similarly, people with high credit scores, may in fact be high risk individuals or people with low purchase power, due to overleveraging or other negative behavior that is not monitored by the credit agencies. Credit scores are also static data points that do not reflect trends or forecasts of a person's future purchase power. Other relevant factors regarding a person, such demographics, personal profile data, and social transactions often provide useful insight into the purchase power and tendencies of the person. Such data is not captured in credit rating or other present purchase ratings used by e-commerce companies. What is needed, therefore, is a buyer rating system that provides more accurate measures of purchase power and purchasing trends of customers compared to the present credit rating reports that are presently used.

### BRIEF DESCRIPTION OF THE DRAWINGS

Embodiments of the present invention are illustrated by way of example and not limited to the figures of the accompanying drawings, in which like references indicate similar elements and in which:

FIG. 1 is a block diagram of a computer network system that implements embodiments of an online purchase power determination process.

FIG. 2 is a diagram that illustrates the derivation of a purchase power score from a plurality of information sources.

FIG. 3 is a diagram that illustrates the linkages of individuals in a social network environment, under an embodiment.

FIG. 4 is a flowchart that illustrates a method of deriving a purchase power score of a user, under an embodiment.

### DETAILED DESCRIPTION

Embodiments of a purchase power determination process for use in electronic commerce (e-commerce) systems are described. The process correlates a person's actual, estimated or modeled credit score information with certain user profile and social network information to compile an overall score that encapsulates the person's purchasing power. The user profile information can include subjective information, such as user preferences, background, affiliations, behavior patterns, and so on. The social network information includes information regarding social network sites used by the person and the actual or estimated credit scores or financial data of other individuals linked to the person through these social networks.

Embodiments can be used in conjunction with any type of electronic commerce or other retail system that provides a basis for providing goods and/or services to be purchased by users. This could be any type of online store, retailer, credit card company or other similar entity. The purchase power determination system provides a metric that represents the purchase power of an individual as a rated number or letter grade or bucketed designation.

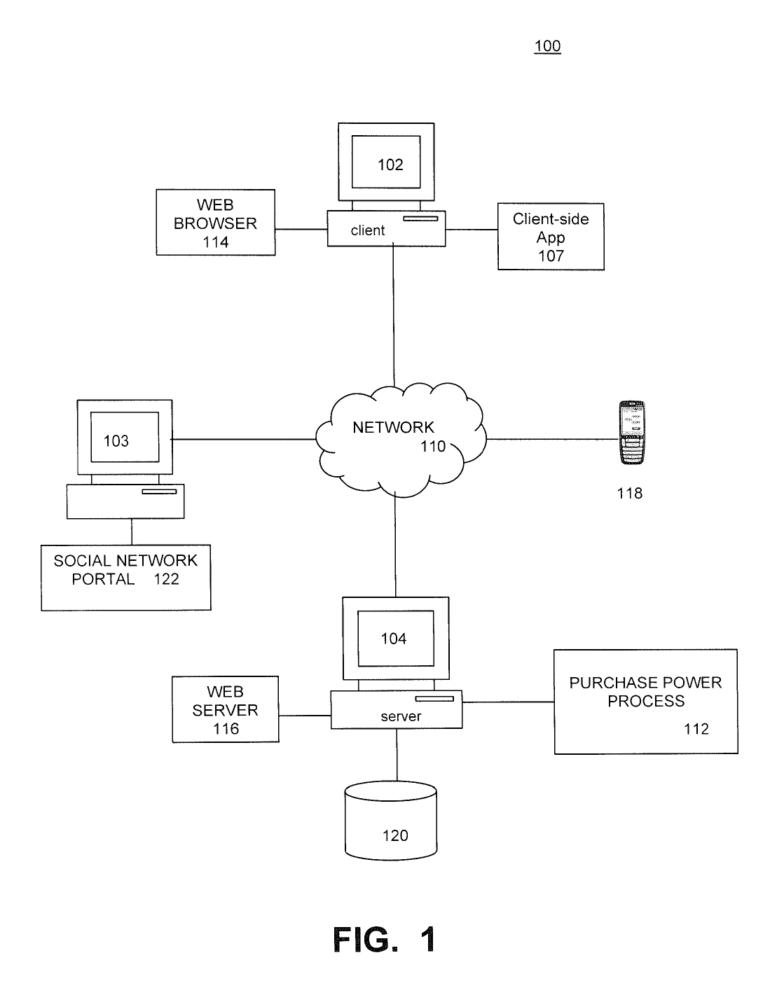

Aspects of the one or more embodiments described herein may be implemented on one or more computers executing software instructions. The computers may be networked in a client-server arrangement or similar distributed computer network. FIG. 1 illustrates a computer network system 100 that implements one or more embodiments. In system 100, a network server computer 104 is coupled, directly or indirectly, to one or more network client computers 102 through a network 110. The network interface between server computer 104 and client computer 102 may include one or more routers that serve to buffer and route the data transmitted between the server and client computers. Network 110 may be the Internet, a Wide Area Network (WAN), a Local Area Network (LAN), or any combination thereof. Network 110 may also represent a cloud-based network environment in which applications, servers and data are maintained and provided through a centralized cloud computing platform.

In one embodiment, the server computer 104 is a World-Wide Web (WWW) server that stores data in the form of web pages and transmits these pages as Hypertext Markup Language (HTML) files over the Internet 110 to the client computer 102. For this embodiment, the client computer 102 typically runs a web browser program 114 to access the web pages served by server computer 104 and any available content provider or supplemental server 103.

In one embodiment, server 104 in network system 100 is a server that executes a server-side purchase power process 112. Client versions of this process 107 may also be executed on the client computers. This process may represent one or more executable programs modules that are stored within network server 104 and executed locally within the server. Alternatively, however, it may be stored on a remote storage or processing device coupled to server 104 or network 110 and accessed by server 104 to be locally executed. In a further alternative embodiment, the purchase power process 112 may be implemented in a plurality of different program modules, each of which may be executed by two or more distributed server computers coupled to each other, or to network 110 separately.

For an embodiment in which network 110 is the Internet, network server 104 executes a web server process 116 to provide HTML documents, typically in the form of web pages, to client computers coupled to the network. To access the HTML files provided by server 104, client computer 102 executes a web browser process 114 that accesses web pages available on server 104 and other Internet server sites, such as content provider 103 (which may also be a network server executing a web server process). The client computer 102 may access the Internet 110 through an Internet Service Provider (ISP). Data for any of the products, credit cards, user information, and the like may be provided by a data store 120 closely or loosely coupled to any of the server 104 and/or client 102. A separate content provider 103 may provide some of the data that is included as part of the user background information.

The client computer 102 may be a workstation computer or it may be a computing device such as a notebook computer, personal digital assistant, mobile device, phone, or the like. The client computer may also be embodied within a mobile communication device 118, game console, media playback unit, or similar computing device that provides access to the Internet network 110 and a sufficient degree of user input and processing capability to execute or access the client-side credit application program 107. The client computers 102 and 118 may be coupled to the server computer 104 over a wired connection, a wireless connection or any combination thereof.

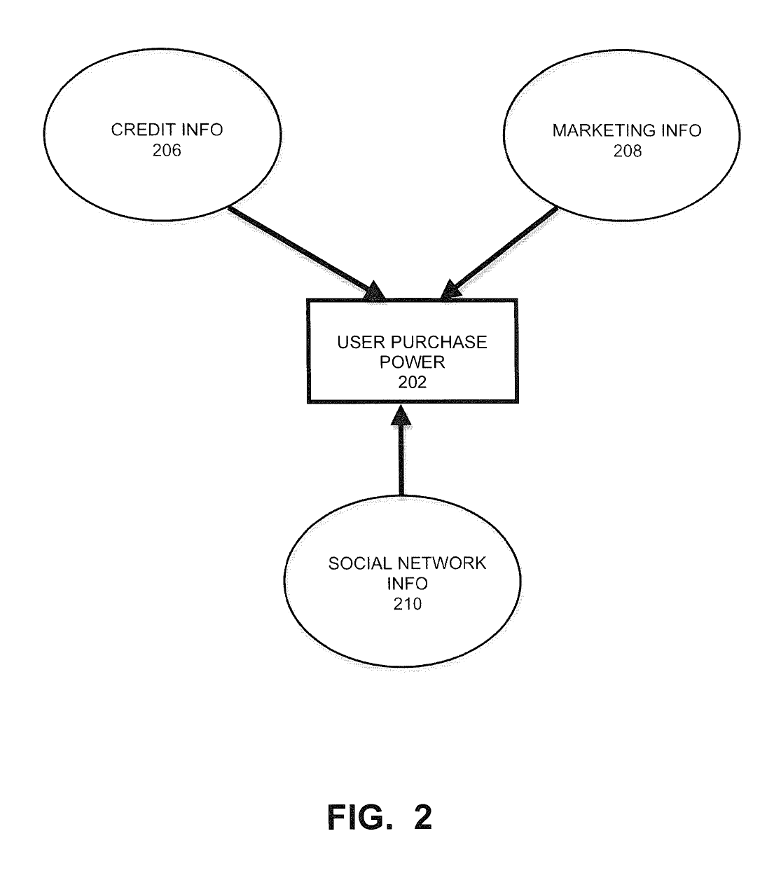

In one embodiment, process 112 receives information regarding the user's personal profile, his or her credit rating information, and certain social network information to derive a user purchase power score or grade. FIG. 2 is a diagram that illustrates the derivation of the purchase power using these items of information.

In an embodiment, the credit information 206 is provided in the form of a credit report that is typically maintained and made available by credit bureaus such as Equifax™, Experian™, or Transunion™. In certain cases, the cost of a credit pull through one of these bureaus may be high. Thus, the credit information 206 can instead comprise simulated credit information, such as may be derived by the user's financial information, such as salary, disposable income score, address, risk information, and other relevant financial information. In some cases, the simulated credit information may be extrapolated from the user's address or zip+4 information along with other pertinent history, e.g., employment, residence, education, and so on. The credit information 206 can thus be simulated/estimated/modeled risk rating made available through non-credit bureau databases, such as a marketing database.

The marketing information 208 is certain profile or personal information of the user, such as name, address, age, profession, marital status, socio-economic data, demographic information, and other possibly relevant personal information. Certain objective financial data can also be included in marketing information 208, such as mortgage balances, property tax values (to extrapolate home value), automobile registrations, outstanding liens, judgments, taxes, and so on. In an embodiment, credit information, social network data, and marketing information are combined to provide a single metric or purchase power score for a user. This metric or score can be assigned as a letter grade, e.g., A, B, C, D, F, or a number within a range, e.g., 1-10, or any similar score, or a bucketed designation.

In an embodiment, the purchase power is based on a person's credit score and may be modified by one or more other parameters, such as the profile or personal information of the user, as described above. The purchase power approximates or represents a person's ability to purchase goods or services of a certain value, in a similar way to how a person's credit score indicates the creditworthiness of an individual with respect to the ability to incur a certain level of debt. The purchase power score may be expressed as a probability, which indicates the probability that a person can afford certain purchases or incur an amount of debt.

In an embodiment, the single purchase power score for a user can be generated by combining the credit information, social network data, and marketing information. The purchase power score can be derived by linearly combining individual metrics assigned to each of the credit information, the social network data, and the marketing information; or it can be a weighted purchase power score derived by weighting at least one of the individual metrics, and then combining the individual metrics.

The social network information 210 is provided by one or more social network sites or services used by the user. Such services may include LinkedIn, Facebook, Twitter, and so on. In general, these social network sites comprise links or relationships between the user and certain other individuals. Such links may be characterized as either direct or indirect. A direct link is an explicit link established between the user and another person through a first-level friend or relationship definition. An indirect link is a link between the user and another person that goes through at least one other person.

A basic premise of the process is that a person is more likely than not to associate with other people of similar backgrounds (such as socio-economic) and those with similar purchase power. Thus, the purchase power of friends or close associates may provide an indication of the purchase power of a person if exact purchase power data for the person is not known or is ambiguous. Another premise of the process is that a person is more likely to directly link with people of similar socio-economic background in social network sites. As is well known, a person cannot choose one's family, or even one's co-workers or other associates. However, one can generally choose one's friends, and this is especially true in the social network environment, where the definition and selection of direct friends is clearly set by both parties and managed through the social network context.

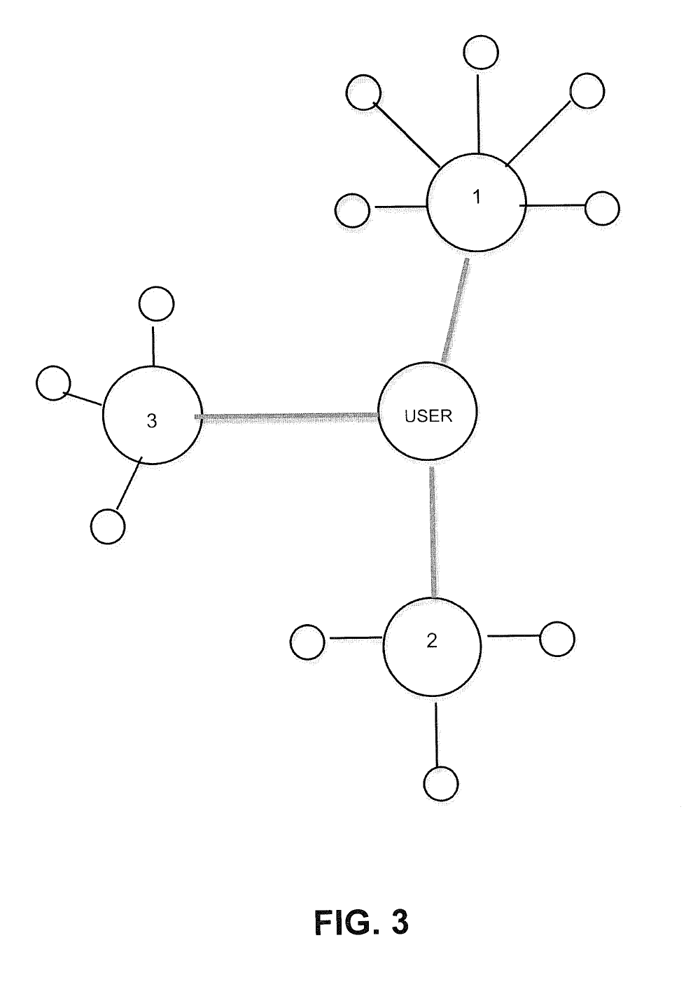

Thus, in an embodiment, the purchase power of individuals directly linked with a user through one or more social network sites is used to derive a measure of the user's purchase power. FIG. 3 is a diagram that illustrates the linkages of individuals in a social network environment, under an embodiment. As shown in FIG. 3, the user is linked directly to at least three other people, denoted 1, 2 and 3. Each of these people, in turn are directly linked to one or more other people in their respective networks. It assumed that the user and his or her direct links have friended each other or otherwise established direct links through the social network site.

The purchase power of each of the user's friends in the network are determined with respect to a probability of each user with respect to a having a particular purchase power score or grade. These values are then used to extrapolate a purchase power score for the user himself. Thus, for example, if each of the user's friends 1, 2 and 3 has a 30% chance of having a grade A purchase power, then it is assumed that within a certain probability, the user could also have a 30% chance of having a grade A purchase power, since these are direct relations in his social network. If, instead, two of these friends are more likely to have a C purchase power grade, the purchase power of the user may be downgraded to reflecting a greater chance that he has a possible B grade instead of an A. The purchase power of the direct friends of the other people 1, 2, and 3, may also affect the purchase power grade of the user, since these people affect the purchase power of their friends, 1, 2, and 3.

In one embodiment, a person's purchase power score is derived by averaging the individual purchase powers of his or her direct and/or indirect friends. Alternatively, one or more different weighting algorithms can be used to derive the user's probable purchase grade depending on the purchase power grade probabilities of his or her direct friends.

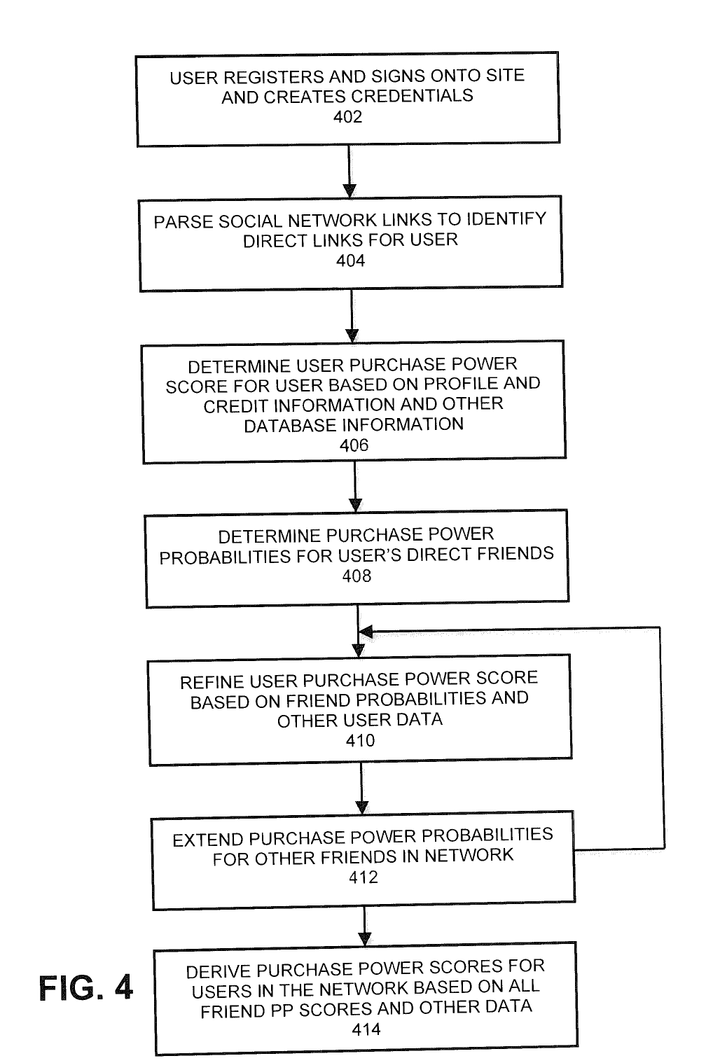

FIG. 4 is a flowchart that illustrates a method of deriving a purchase power score of a user, under an embodiment. As shown in FIG. 4, the process begins, block 402, with the user logging into the purchase power determination site and creating or providing credentials for the site. In an embodiment, the purchase power determination site comprises a web site or other communications platform that provides the functionality of server 104 illustrated in FIG. 1. This site provides a user interface for communication with a user accessing the site through a client computer 102 or 118.

The information provided by the user in block 402 can include providing personal identification information, as well as certain background information. The site then uses this information to access or generate certain items of marketing information 208 about the user. The site can also use this information to obtain actual, estimated or modeled credit risk information 206 for the user. The credentials can also include log-in or account information for the user with regard to one or more social network sites, such as Facebook, LinkedIn or other similar sites. The process then parses the social network links of the user within these social network sites to identify the direct links of the user, block 404. The process then determines probabilities of purchase power scores for these friends based on information provided in these sites, or gained from publically accessible data for these people, block 408. The process also determines an initial purchase power score for the user based on actual, estimated or modeled credit risk and/or marketing information provided or acquired through the log-in or signup process, and other relevant database information for the user, block 406. The process then combines the initial purchase power score with the probability scores of the user's friends to refine or modify the purchase power score for the user, block 410. This purchase power score may be expressed as an individual numeric score or letter grade, or it may be provided as a probability, that is the user is x % likely to have a grade of A, B, C, D, or F. Alternatively, a histogram or probability distribution may be provided.

In an embodiment, the process is extended to determine the purchase power probabilities for all indirect friends (friends of friends) of the user in the network. Thus, the purchase power of friends connected to the user's direct friends in block 408 are determined, block 412. The purchase power probabilities of these direct friends may then be used to further refine the user's purchase power score, as illustrated by the feedback loop back to block 410. The purchase power probabilities for all of these indirect friends also allows the system to essentially derive the purchase power scores for all of the users in the network for whom relevant data is available, such as other information related to these users, block 414.

A particular weighting scheme may be used to process the credit rating, marketing information, and social network data. For example, for these three components, an equal weighting of 33.3% each may be assigned to each component to derive the final score. Alternatively, different weights may be assigned to each component, such as 50% to the social network data and 25% each to the credit and marketing data, or any other desired weighting formula.

In an embodiment, trend data is analyzed to modify or determine the purchase power of a user. If a user's actual, estimated or modeled credit risk rises or falls for a defined period of time prior to the time that this risk score is obtained, this is factored into the final purchase power score. Similarly if the user changes network links, such as linking with people of higher or lower socio-economic profiles, this can also be factored into the final score or may be appended to their profile in a social or other network.

The purchase power score correlates to the risk of the user with regard to fulfilling financial obligations and transactions. It may be used by vendors or other interested parties to determine the types of goods and services to offer to the user. It may also be used to determine whether and how much credit to offer to a user, or to establish the cost or discounts of goods, services, credit, and so on. It may further be used by advertisers as the basis of directing targeted ads to users, such that certain ads are delivered to people based on their purchasing power or probable purchasing power. The purchase power data may be encapsulated in a cookie or similar data object that is provided on the client device or in a client profile.

Aspects of the process and system described herein may be implemented as software instructions executed by a processor, or as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Non-transient computer-readable media in which such formatted data and/or instructions may be embodied include, but are not limited to, non-volatile storage media in various forms (e.g., optical, magnetic or semiconductor storage media).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

It should be understood that the arrangement of components illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the figures. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

The above description of illustrated embodiments is not intended to be exhaustive or to limit the embodiments to the precise form or instructions disclosed. While specific embodiments of, and examples are described herein for illustrative purposes, various equivalent modifications are possible within the scope of the described embodiments, as those skilled in the relevant art will recognize. The elements and acts of the various embodiments described above can be combined to provide further embodiments.

What is claimed is:

1. A computer-implemented method comprising:
on a first server computer coupled to a client computer operated by a user, receiving a request by the user to commence electronic commerce over a network;
identifying one or more links to other users through one or more social network applications utilized by the user;
determining a purchase power score for each of the other users; and
deriving a purchase power score for the user based on corresponding purchase power scores for the other users.

2. The method of claim 1 wherein the purchase power score is based directly or indirectly on a credit rating of the respective user.

3. The method of claim 2 wherein the purchase power score is modified by additional information on the respective user, wherein the additional information includes characteristics selected from the group consisting of: address, age, profession, marital status, socio-economic data, and demographic information.

4. The method of claim 3 wherein the purchase power score is further modified by objective financial data of the respective user, wherein the objective financial data is selected from the group consisting of: mortgage balance, property tax values, automobile registration fees, outstanding liens, judgments, and taxes.

5. The method of claim 4 further comprising combining the credit information, social network data, and marketing information to provide a single purchase power score for the respective user.

6. The method of claim 5 wherein the purchase power score is expressed as one of a letter grade or a number within a range to define a value along a scale indicating a low purchase power to a high purchase power.

7. The method of claim 7 wherein the purchase power score for a respective user represents a probability that the respective user can afford purchases or debt of a certain minimum value.

8. The method of claim 5 wherein the purchase power score is derived by combining individual metrics assigned to each of the credit information, the social network data, and the marketing information.

9. The method of claim 8 further comprising weighting at least one of the individual metrics to produce a weighted purchase power score.

10. The method of claim 1 wherein the derived purchase power score for the user is produced by averaging the determined purchase power score for each of the other users.

11. The method of claim 10 wherein each of the other users represents people directly linked to the user through one link in a social network application.

12. The method of claim 11 wherein at least some of the other users represent secondary people indirectly linked to the user through two or more links in the social network application.

13. The method of claim 12 wherein the derived purchase power score is a weighted score derived by weighting at certain of the other users scores by one or more of a characteristic of each of the other users or a degree of separation from the user by each of the other users.

14. A system comprising:
means for receiving a request by the user to commence electronic commerce over a network;
means for identifying one or more links to other users through one or more social network applications utilized by the user;
means for determining a purchase power score for each of the other users; and
deriving a purchase power score for the user based on corresponding purchase power scores for the other users;

15. The system of claim 14 wherein the purchase power score is based directly or indirectly on a credit rating of the respective user, and wherein the purchase power score is modified by additional information the respective user, and further wherein the additional information includes characteristics selected from the group consisting of: address, age, profession, marital status, socio-economic data, and demographic information, and yet further wherein the purchase power score is further modified by objective financial data of the respective user, wherein the objective financial data is selected from the group consisting of: mortgage balance, property tax values, automobile registration fees, outstanding liens, judgments, and taxes.

16. The system of claim 15 further comprising combining the credit information, social network data, and marketing information to provide a single purchase power score for the respective user, and wherein the purchase power score is expressed as one of a letter grade or a number within a range to define a value along a scale indicating a low purchase power to a high purchase power.

17. The system of claim 16 wherein the purchase power score for a respective user represents a probability that the respective user can afford purchases or debt of a certain minimum value, and wherein the purchase power score is derived by one of: combining individual metrics assigned to each of the credit information, the social network data, and the marketing information, and weighting at least one of the individual metrics to produce a weighted purchase power score.

18. The system of claim 14 wherein the derived purchase power score for the user is produced by averaging the determined purchase power score for each of the other users.

19. The system of claim 18 wherein at least some of the other users represent people directly linked to the user through one link in a social network application, and secondary people indirectly linked to the user through two or more links in the social network application.

20. The system of claim 19 wherein the derived purchase power score is a weighted score derived by weighting at certain of the other users scores by one or more of a characteristic of each of the other users or a degree of separation from the user by each of the other users.
